(19) United States
(12) Patent Application Publication
(10) Pub. No.: US 2023/0265242 A1
(43) Pub. Date: Aug. 24, 2023

(54) COMPOSITIONS AND RELATED METHODS FOR CLOSED-LOOP RECYCLING OF POLYESTERS

(71) Applicant: BOARD OF TRUSTEES OF MICHIGAN STATE UNIVERSITY, East Lansing, MI (US)

(72) Inventor: Muhammad Rabnawaz, East Lansing, MI (US)

(21) Appl. No.: 18/005,227

(22) PCT Filed: Jul. 14, 2021
(86) PCT No.: PCT/US21/41514

§ 371 Date: Jan. 12, 2023

Related U.S. Application Data
(60) Provisional application No. 63/052,289, filed on Jul. 15, 2020.

(51) Int. Cl. C08G 63/91; C08K 5/1515; C08J 11/22

(52) U.S. Cl. CPC C08G 63/912; C08K 5/1515; C08J 11/22; C08J 2367/04

(57) ABSTRACT

The disclosure relates to a recyclable polyester composition including a polyester, an epoxide compound, and optionally a capping agent. The epoxide compound can be a sterically hindered epoxide and/or a polyfunctional epoxide. The capping agent can be selected and included based on its ability to react with in situ-generated hydroxy groups resulting from reaction with the polyester and the epoxide compound. The capping agent is included when the epoxide compound is a polyfunctional epoxide in order to control or limit branching during chain extension. The inclusion of the epoxide compound provides a controlled chain extension of the polyester subjected to thermal processing in a way that controls, limits, or prevents branching and crosslinking, but which also increases polymer molecular weight in a manner that offsets the molecular weight reduction associated with thermal processing in the absence of the disclosed epoxide compounds.

### CROSS REFERENCE TO RELATED APPLICATION

Priority is claimed to U.S. Provisional Application No. 63/052,289 (filed Jul. 15, 2020), which is incorporated herein by reference in its entirety.

### STATEMENT OF GOVERNMENT INTEREST

None.

### BACKGROUND OF THE DISCLOSURE

### Field of the Disclosure

The disclosure relates to a recyclable polyester composition including a polyester, an epoxide compound, and optionally a capping agent. The epoxide compound can be a sterically hindered epoxide and/or a polyfunctional epoxide. The epoxide compound provides controlled chain extension of the polyester subjected to thermal processing in a way that controls, limits, or prevent branching and crosslinking, but which also increases polymer molecular weight in a manner that offset the molecular weight reduction associated with thermal processing.

### Brief Description of Related Technology

Polyesters, in particular polyethylene terephthalate (PET), are widely used in packaging (e.g., bottle, film, foams). Polyesters are also heavily used as fiber and engineering material owing to their excellent mechanical strength, good chemical resistance, good electrical insulation, thermal resistance. As a result of these enormous applications, PET is becoming a leading source of plastic pollution and efforts have been focused on recycling techniques. However, recycled PET is of low quality (e.g., poor mechanical properties, low viscosity) caused by the degradation of molecular weight during melt-processing.

Polyesters are usually recycled through either a chemical or mechanical recycling process. Chemical recycling involves the conversion of PET polymer into its original small molecule feedstock or oligomers. The main disadvantage of chemical recycling is the high cost of energy associated with the high-temperature depolymerization of PET and the purification of the chemical products formed as a result of PET depolymerization. Mechanical recycling involves the conversion of recycled PET flakes into pellets/granules in a routine extrusion process. The mechanical recycling of PET and other polyesters are economically viable and environmentally friendly. However, high temperature extrusion which is necessary for making granules from flakes has contaminants such as absorbed moisture and acid moieties that lead to PET granules of low molecular weight. These side products compromise the mechanical properties of PET and lead to undesirable low viscosities. These lost performances are often compensated by addition of virgin plastics, by solid stating, or by chain extender methods.

Virgin plastic addition uses as much as 70% new polyester to maintain satisfactory performance. Solid stating or solid state polymerization is a slow recycling process that leads to crosslinking and degradation and requires large special equipment. Chain extenders usually utilizes bifunctional compounds to couple polyester chains together upon chemical reactions between chain extenders and polyesters ends groups (OH, COOH). This coupling yields polyesters of high molecular weight and high melt-viscosities. Chain extension can be readily done in a reactive extrusion with shorter reaction times, thus being compatible with industrial high speed processing. Several chain extenders including diisocyanates, dianhydrides, bisoxazolines, carbodiimides, phthalimides, and epoxides have been successfully tested with polyesters. The main problem with these chain extenders during mechanical recycling is that they lead to branching and side reactions.

### SUMMARY

In one aspect, the disclosure relates to a recyclable polyester composition comprising: a polyester; an epoxide compound comprising at least one of a sterically hindered epoxide and a polyfunctional epoxide (e.g., difunctional epoxide or having 2+epoxide groups); and optionally a capping agent reactive with in situ-generated hydroxy groups resulting from reaction with the polyester and the epoxide compound (e.g., during mechanical recycling or other high-temperature melt-processing), wherein the capping agent is present when the polyester composition comprises the polyfunctional epoxide. Suitable capping agents can include acetylated compounds such as acetylated bulky phenols and oxazoline compounds such as a mono-oxazoline, and isocyanate compounds such as mono-isocyanates. More generally, the capping agent can be any compound reactive with the in situ-generated hydroxy groups without creating a harmful byproduct, thus serving as a means to limit or control undesired branching and crosslinking. The polyester can be a virgin polyester or a recycled polyester (e.g., and already re-used), such that it can incorporated into the recyclable polyester composition for a second or subsequent recycling process. Put another way, polyesters can be recycled multiple times using the disclosed compositions and methods after several product lifecycles in which a polyester product is made, used until its end of life, recycled according to the disclosure, and then re-formed into a new polyester product.

In a refinement, the polyester comprises a thermoplastic polyester reaction product between an alkylene diol and a dicarboxylic acid. Suitable dicarboxylic acids can include aromatic, aliphatic, or cycloaliphatic dicarboxylic acids. Example aromatic dicarboxylic acids include 2,6-naphthalenedicarboxylic acid, terephthalic acid, and isophthalic acid, and mixtures of these. The aromatic ring can be substituted, for example with a halogen, such as chlorine or bromine, or C1-C4 alkyl, such as methyl, ethyl, isopropyl, n-propyl, n-butyl, isobutyl, or tert-butyl group. The dicarboxylic acid can also have a heteroatom-substituted ring (e.g., an aromatic ring including one or more N, O, or S heteroatoms), for example as furan-2,5-dicarboxylic acid. Example aliphatic or cycloaliphatic dicarboxylic acids include adipic acid, succinic acid, azelaic acid, sebacic acid, dodecanedioic acids, and cyclohexanedicarboxylic acids. Suitable alkylene diols can include aliphatic or cycloaliphatic dihydroxy compounds, for example diols having from 2 to 6 carbon atoms, in particular 1, 2-ethanediol, 1,3-propanediol, 1,4-butanediol, 1,6-hexanediol, 1,4-hexanediol, 1,4-cyclohexanediol, 1,4-cyclohexanedimethylanol, and neopentyl glycol, and mixtures of these.

In a refinement, the polyester comprises polyethylene terephthalate (PET). More generally, the polyester can include one or more polyalkylene terephthalates preferably having from 2 to 10 carbon atoms in the alkylene diol moiety. Polyalkylene terephthalates of this type can be prepared by reacting aromatic dicarboxylic acids, or their esters or other ester-forming derivatives, with suitable dihydroxy compounds as described above. Specific examples include polyethylene terephthalate, polytrimethylene terephthalate, polybutylene terephthalate, and polyalkylene furaonate (e.g., polyethylene furanoate, polypropylene furanoate).

In a refinement, the polyester comprises polylactic acid (PLA). More generally, in addition to the diol/diacid polyester reaction products mentioned above, the polyester can include a thermoplastic polyester reaction product of a single monomer having hydroxy and acid functionality (e.g., mono-hydroxy and mono-acid). Suitable additional polyesters can include polyglycolic acid (PGA or polyglycolide), polylactic acid (PLA or polylactide), polyhydroxyalkanote (PHA) (e.g., poly(3-hydroxybutyrate), poly(3-hydroxyvalerate), and polylactone (e.g., polycaprolactone (PCL), polybutyrolactone, polyvalerolactone).

In a refinement, the polyester comprises a thermoplastic polyester reaction product between an epoxide compound and an anhydride compound. Such reaction products can be prepared via catalyzed and uncatalyzed ring opening polymerization. Suitable polyesters can include those prepared from the copolymerization of a mono-substituted epoxide, for example 1,2-epoxy alkanes, epoxy cycloalkanes, epoxy aromatics, etc. (e.g., alkanes, aromatics, or other hydrocarbons having at least 2, 4, 6, 8, or 10 and/or up to 6, 10, 14, 20, or 30 carbon atoms in their skeleton) with a cyclic anhydride, for example maleic anhydride, phthalic anhydride, itaconic anhydride, etc.

In a refinement, the recyclable polyester composition comprises the sterically hindered epoxide. This refinement limits side reactions during recycling by generating hindered (e.g., tertiary) hydroxy groups. A hindered hydroxy group can be expressed a R₁R₂R₃COH, where the R groups are all other than hydrogen (e.g., including a carbon atom linked to other atoms).

In a particular refinement, the sterically hindered epoxide has a structure according to formula (I):

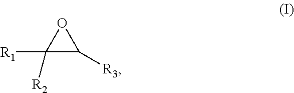

wherein: R₁ is an alkyl or an aryl group; R₂ is hydrogen, an alkyl group, or an aryl group; and R₃ is hydrogen, an alkyl group, an aryl group, or together with R₁ is a cycloalkyl group. Suitably, at least one of R₂ and R₃ is other than hydrogen. The alkyl and aryl groups of R₁, R₂, and R₃ can be the same or different, and they can be hydrocarbons including at least 1, 2, 4, 6, 8, 10, 15, or 20 and/or up to 4, 6, 10, 14, 20, 30, 40, 50, or 60 carbon atoms. The hydrocarbons can be any of linear, branched, cyclic, aliphatic, aromatic, etc., and they can include heteroatoms (e.g., N, O, S) or other epoxide functional groups. In various embodiments, the sterically hindered epoxide includes 1, 2, or more than two epoxide groups.

In a particular refinement, the sterically hindered epoxide is selected from the group consisting of (+)-limonene 1,2-epoxide, alpha-pinene 1,2-epoxide, (−)-caryophyllene 1,2-epoxide, cyclooctane 1,2-epoxide, styrene 1,2-epoxide, and epoxidized oils. Suitable epoxidized oils can include epoxidized plant or other natural-based oils (e.g., fatty acid triglycerides with 1, 2, or more than two epoxide groups on the pendant fatty acid chains).

In a refinement, the recyclable polyester composition comprises the polyfunctional epoxide and the capping agent (e.g., acetylated bulky phenols and/or oxazoline compounds). This embodiment can limit side reactions during recycling by generating hydroxy groups and reacting them in situ during mechanical recycling with a capping agent such as an acetylated bulky phenol. A mono-oxazoline capping agent can limit side reactions by reacting with the in situ-generated hydroxy groups resulting from ring opening.

In a particular refinement, the polyfunctional epoxide comprises at least two hindered epoxy functional groups. For example, the polyfunctional epoxide can have at least 2, 3, 4, 6, 8, 10, 20, or 30 and/or up to 10, 20, 40, 60, 80, or 100 hindered epoxy groups. The steric hindrance at each hindered epoxide group can be similar or otherwise analogous to that described above for formula (I). Examples include cyclooctene diepoxide, epoxided plant oils with multiple epoxide groups, diepoxy limonenes, diepoxy benzene (e.g., epoxidized divinyl benzene), etc. In addition, polymers or copolymers of 4-epoxy-styrene and other polymerizable hindered epoxides can be used as a polyfunctional chain extender according to the disclosure.

In a particular refinement, the capping agent comprises an acetylated bulky phenol having a structure according to formula (II):

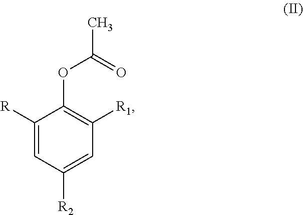

wherein: R is hydrogen, a linear alkyl group (e.g., H, methyl, ethyl), or a branched alkyl group (e.g., tert-butyl); R₁ is a branched alkyl group (e.g., tert-butyl); and R₂ is a hydrocarbon group (e.g., alkyl group such as methyl or a hydrocarbon chain with one or more heteroatoms or other functional group, such as an ester group). More generally, the alkyl groups of R, R₁, and R₂ can be the same or different, and they can be hydrocarbons including at least 1, 2, 4, 6, 8, or 10 and/or up to 4, 6, 10, 14, or 20 carbon atoms. The hydrocarbons can be any of linear, branched, cyclic, aliphatic, aromatic, etc., and they can include heteroatoms (e.g., N, O, S) or other functional groups. More generally, the acetylated bulky phenol includes an acetylated phenolic group, which can be represented by CH₃(C═O)O-Ph, where Ph is a phenyl group that contains at least one bulky substituent on the phenyl ring in an ortho position relative to the acetyl group (CH₃(C═O)). The bulky substituent can be a tert-butyl or other branched or cyclic hydrocarbon. In some embodiments, the acetyl group (CH₃(C═O)) can be replaced more generally with a longer alkyl or aromatic carbonyl group R(C═O), where R can be a hydrocarbon group with 1 to 10 carbon atoms (e.g., at least 1, 2, or 4 and/or up to 4, 6, 8 or 10 carbon atoms), such as a linear or branched alkyl group or an aromatic group. In some embodiments, the phenolic group can be replaced more generally with a dimeric or polyphenolic group, for example a hindered phenol such as 3,5-di-tert-butyl-4-hydroxy benzyl acrylate.

In a particular refinement, the capping agent comprises a mono-oxazoline. The oxazoline ring can be unsubstituted or substituted, for example with a halogen, an alkyl or other hydrocarbon group, etc.

In a particular refinement, the polyfunctional epoxide is selected from the group consisting of cyclooctene diepoxide, polyepoxided plant oils, diepoxy limonenes, polymers or copolymers of 4-epoxy-styrene, and combinations thereof; and the capping agent is selected from the group consisting of acetylated butylated hydroxytoluene (BHT), polymers and copolymers of 3,5-di-tert-butyl-4-hydroxy benzyl acrylate, a mono-oxazoline, and combinations thereof.

In a refinement, the polyester is present in the recyclable polyester composition in an amount ranging from 50 wt. % to 99 wt. %; and the epoxide compound is present in the recyclable polyester composition in an amount ranging from 0.1 wt. % to 50 wt. %. Suitably, the polyester can be at least 50, 60, 70, or 80 wt. % and/or up to 70, 80, 90, 95, 98, or 99 wt. % of the recyclable polyester composition. Alternatively or additionally, the epoxide compound can be at least 0.1, 1, 2, 5, 10, 15, 20, or 30 wt. % and/or up to 10, 20, 30, 40, or 50 wt. % of the recyclable polyester composition. Alternatively or additionally, at least 90, 95, 98, or 98 wt. % of the recyclable polyester composition is the polyester, the epoxide compound, and the capping agent (when present) combined (e.g., 1, 2, 5, or 10 wt. % or less of other additives or components besides the polyester, epoxide compound, and capping agent. The capping agent, when present, is suitably at least 0.1, 1, 2, or 5 wt. % and/or up to 2, 3, 5, 7, or 10 wt. % of the recyclable polyester composition.

In a refinement, the composition further comprises one or more additives selected from the group consisting of nanoclay, graphene oxide, graphene, fibers, silicon dioxide (silica), aluminum oxide, cellulose nanocrystals, carbon nanotubes, titanium dioxide (titania), diatomaceous earth, biocides, pigments, dyes, thermoplastics, and combinations thereof. The polyester composition can include any suitable organic or inorganic filler or additive, which can be included to improve one or more of mechanical properties, optical properties, electrical properties, and omniphobic properties of the final composition. Examples of suitable fillers or additives include nanoclay, graphene oxide, graphene, fibers (e.g., carbon fiber, glass fiber, aramid fiber), silsesquioxane, silicon dioxide (silica), aluminum oxide, diatomaceous earth, cellulose nanocrystals, carbon nanotubes, titanium dioxide (titania), and combinations or mixtures thereof. In addition, the fillers can include biocides, pigments, dyes, a thermoplastic material, or a combination thereof. The fillers can be added in the range from 0.01 wt. % to 10 wt. % or 0.01 wt. % to 50 wt. %, for example in range from 1 wt. % to 5 wt. % or 1 wt. % to 20 wt. %.

In another aspect, the disclosure relates to a method for recycling a polyester composition, the method comprising: providing a recyclable polyester composition according to any of the variously disclosed embodiments; and thermally processing (e.g., melt-processing, such as extruding) the recyclable polyester composition to provide a recycled polyester composition.

The thermal processing suitably includes a melt-processing step. The melt-processing generally corresponds to a mechanical recycling step in which the thermoplastic polyester to be recycled (i.e., the recyclable polyester composition) is heated to a temperature above its melting temperature and below its decomposition temperature, for example in an extruder, so that it can be formed into any desired shape (e.g., pellets or granules for any desired subsequent use). The additives (epoxide compounds, capping agents) can be added directly into the polyesters or first converted into a masterbatch and then added into the remaining portion of polyesters. Common melt-processing temperatures can range from about 80° C. to 280° C. (e.g., at least 80, 150, or 200° C. and/or up to 150, 200, 250, or 280° C.), which is typically suitable for common polyesters such as PET and PLA. Higher or lower temperatures may be suitable for other polymers with varying melting points. For example, melt-processing can be performed at a temperature that is at least 10 or 20° C. and/or up to 50 or 100° C. above the melting point of the polyesters. The recycling process has the benefit that the addition of the particular epoxide components offsets the typical reduction in molecular weight and/or viscosity associated with mechanical recycling. In an alternative embodiment, the recyclable polyester composition can be thermally processed via solid stating (e.g., instead of melt-processing or extrusion) to form the recycled polyester composition.

Various refinements of the disclosed recycling method are possible.

In a refinement, thermally processing the recyclable polyester composition comprises reacting the epoxide compound with at least one of (i) hydroxyl end groups on polymeric chains of the polyester and (ii) carboxylic end groups on polymeric chains of the polyester, thereby chain-extending the polyester. Chain extension of the polyester can be performed in a manner that limits or prevents introduction of branching or crosslinking reactions. For example, a diepoxide compound can be used to prevent branching and crosslinking. In the case of a polyepoxide compound with more than two epoxide groups, branching is present but controlled by the capping agent.

In a refinement, the polyester has a first viscosity prior to recycling; the polyester has a second viscosity after recycling; and the ratio of the first viscosity:second viscosity is at least 0.7, 0.8, or 0.9. The upper bound for the viscosity ratio is not particularly limited, but in various embodiments it can be up to 1.2, 1.5, 2, 5, 10, 20, 50, 100, or 1000. In some embodiments, it can be desired to obtain a final viscosity comparable to the initial viscosity such that the ratio could be up to 1.2, 1.5, or 2. In other embodiments, it can be desired to substantially increase the viscosity while still retaining the thermoplastic character of the polymer. In such cases, the amount of the epoxide compound can be adjusted to provide controlled chain extension to create longer polymer chains with correspondingly higher polymer viscosities, but without introducing substantial branching or crosslinking. In such cases, the viscosity ratio could be up to 5, 10, 20, 50, 100, or 1000. The first and second viscosity values (and corresponding ratio) similarly can apply to the recyclable polyester composition and recycled polyester composition, respectively for the before/after comparison. Viscosity can be measured using any suitable viscometer, for example measuring the viscosity of the molten polymer composition itself or a solution of the polymer composition dissolved in a suitable solvent. The two viscosity values can be measured at any suitable reference conditions (e.g., temperature, concentration, etc.) as long as the reference conditions are the same for both measurements (i.e., providing a consistent ratio for comparison). The final viscosity of the polyester or corresponding polymer composition can be further adjusted to have a melt-flow index suitable for subsequent downstream processing into a new product, for example processing via injection molding, extrusion blown films, extrusion blow molding, etc.

In a refinement, the polyester has a first molecular weight prior to recycling; the polyester has a second molecular weight after recycling; and the ratio of the first molecular weight:second molecular weight is at least 0.7, 0.8, or 0.9. The upper bound for the molecular weight ratio is not particularly limited, but in various embodiments it can be up to 1.2, 1.5, 2, 5, 10, 20, 50, 100, or 1000. In some embodiments, it can be desired to obtain a final molecular weight comparable to the initial molecular weight such that the ratio could be up to 1.2, 1.5, or 2. In other embodiments, it can be desired to substantially increase the molecular weight while still retaining the thermoplastic character of the polymer. In such cases, the amount of the epoxide compound can be adjusted to provide controlled chain extension to create longer polymer chains with correspondingly higher polymer molecular weights, but without introducing substantial branching or crosslinking. In such cases, the molecular weight ratio could be up to 5, 10, 20, 50, 100, or 1000. This ratio can based on either the number-average or weight-average molecular weight. After an initial mechanical recycling process with thermal processing, the polyester could exhibit a reduction of molecular weight of up to 80%. The epoxide compound chain extenders of the present disclosure can offset this reduction and recover/increase the molecular weight of the recycled polyester without substantial branching or crosslinking. The recycled polyester can broadly have a molecular weight in a range of 1000-10,000,000 g/mol after the chain extension, for example at least 1,000, 10,000, 100,000, 1,000,000 and/or up to 10,000, 100,000, 1,000,000, or 10,000,000 g/mol (e.g., number- or weight-average).

In a refinement, providing the recyclable polyester composition comprises: providing the polyester (e.g., as a used polyester to be recycled or a virgin polyester upon initial thermal processing); and adding the epoxide compound and the capping agent (when present) to the polyester (e.g., before or potentially during thermally processing). In some embodiments, the polyester to be recycled can come from any source and can be recycled by adding the specific epoxide compounds at the point of recycling. Thus, a recyclable polyester composition including the polyester and epoxide compound can be formed at the point of recycling, for example before or during melt-processing or other thermal processing. In another embodiment, the epoxide compound can be incorporated into a virgin polyester product so that the polyester as initially made and sold in a product is “recycling-ready” by a conventional mechanical recycling process without the recycler needing to add the epoxide. More generally, during the melt-processing, polyesters undergo molecular weight change (generally reduction). Therefore, the epoxide compound additives can be used with the virgin polyesters to avoid weight loss in first place as well as with recyclable/recycled polyesters where weight loss would otherwise occur or has already taken place.

In a refinement, recyclable polyester composition has already been thermally processed/recycled at least one time prior to a second or subsequent recycling process. In some cases, epoxide compound and capping agent (when present) can be present in the recyclable polyester composition in residual amounts remaining after at least some epoxide compound and capping agent has been consumed in an earlier recycling process. For example, a recyclable polyester composition when originally formed can include sufficient epoxide compound and capping agent such that only a portion is consumed during a single recycling/thermal processing process, thus retaining at least some epoxide compound and capping agent for a subsequent recycling/thermal processing process without addition of further additives. In other cases, fresh epoxide compound and capping agent (when present) can be added to the polyester composition before or during thermal processing to ensure sufficient chain extension.

In another aspect, the disclosure relates to a recycled polyester composition, for example recyclable polyester composition according to any of the variously disclosed embodiments that has undergone the recycling process according to any of the variously disclosed embodiments. Such recycled polyester compositions can be characterized as a reaction product between the polyester, the epoxide compound, and the capping agent (when present).

While the disclosed articles, apparatus, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 illustrates representative Epoxide reactions with carboxylic (COOH; top) and hydroxyl (OH; bottom) functional groups.

FIG. 2 illustrates representative reactions taking place during the melt-extrusion chain extension of PET with diepoxy compound, where branching occurs during the second reaction where the hydroxyl groups undergo transesterification and/or reaction with epoxy groups.

FIG. 3 illustrates a reaction scheme for recycling a polyester composition using a polyfunctional epoxide leading to a crosslinked or branched structure.

FIG. 4 illustrates reaction schemes for recycling a polyester composition using a sterically hindered epoxide according to the disclosure (top: general scheme; bottom: illustrative scheme for a particular sterically hindered epoxide).

FIG. 5 illustrates reaction schemes for recycling a polyester composition using a polyfunctional epoxide and a capping agent according to the disclosure (top: general scheme; bottom: illustrative scheme for a particular capping agent).

FIG. 6 illustrates representative epoxide structures.

FIG. 7 illustrates representative acetylated antioxidant (AO-Ac) structures that can be used as capping agents according to the disclosure.

FIG. 8 illustrates representative reactions that can occur or can be inhibited/prevented when using capping agents according to the disclosure.

FIG. 9 illustrates measured tensile properties for thermally processed polyester compositions according to the disclosure.

### DETAILED DESCRIPTION

The disclosure is generally directed to chain extenders and hydroxyl-group masking agents for recycling of polyesters, for example closed-loop mechanical recycling, which enhances the performance and thus promotes the recyclability of the polyesters. This approach is generally applicable to all types of polyesters, but polyethylene terephthalate (PET) and poly(lactic acid) (PLA) are of particular interest because of their widespread use and their associated recycling issues.

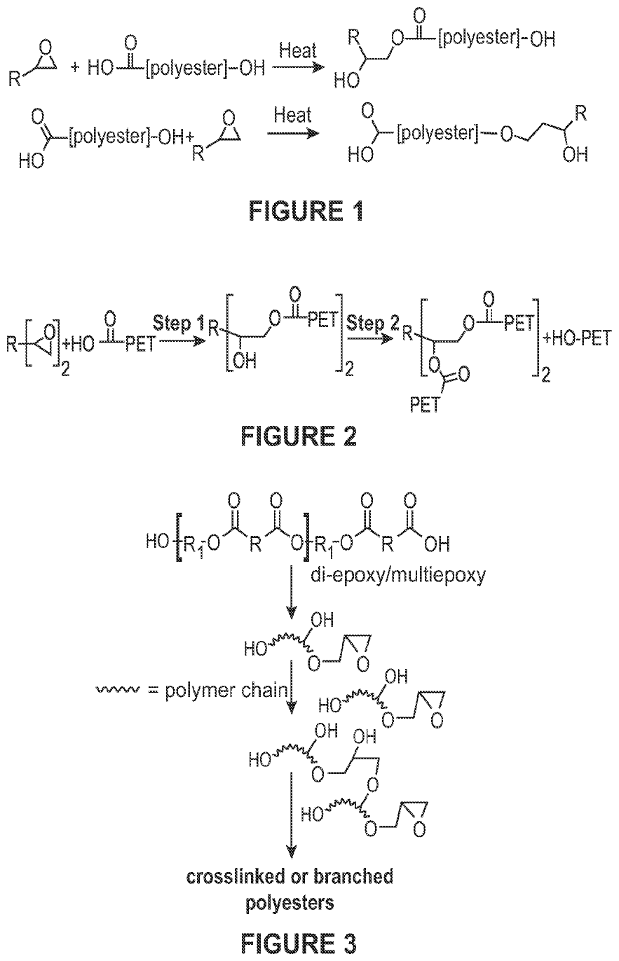

As noted above, diepoxides are commonly used chain extenders in the melt-processing of polyesters. Epoxides react preferentially with carboxyl groups to form stable ester linkages, and with the hydroxyl end-groups of PET or other polyesters to form ether linkages (FIG. 1). At high temperatures, the main reaction is that between carboxylic acid and epoxide groups, while hydroxyl groups that are formed during the reaction of carboxylic acid and epoxide groups also participate in reactions leading to the formation of branching and crosslinking. Epoxies are easily produced and easily integrated with melt-processing in extruders. In addition, unlike isocyanates, they are also less sensitive to moisture. However, a significant problem with the use of a diepoxide or polyepoxide (e.g., a monomeric or oligomeric polyepoxide) chain extender is the generation and introduction of hydroxyl groups on the backbone of the chain-extended polyesters, which hydroxyl groups can further react and lead to uncontrolled branching or even crosslinking. Crosslinking reactions can also be initiated during melt processing via the formation of peroxy radicals, which is often controlled via the addition of suitable additives. However, in the case of polyesters, crosslinking occurs primarily due to the etherification that is caused by the reactions between epoxy moieties and newly generated hydroxyl groups that are created via the epoxy ring-opening reactions. An excessive amount of the chain extender leads to crosslinking reactions, resulting in undesirable gel formation. Another reaction that leads to branching (and crosslinking) is transesterification of the hydroxyl group (FIG. 2). When using such di- or polyepoxide chain extenders, instead of forming a linear chain-extended polyester structure, star-like and even crosslinked polyesters are formed that can drastically affect the physico-mechanical performance of the polyesters. FIG. 3 further illustrates reactions and crosslinked or branched structures that can result when recycling a polyester composition using a conventional di- or polyepoxide chain extender.

The disclosed compositions and methods can address can be used to upgrade used polyesters, commonly from plastic bottles, to maintain its molecular weight and viscosity needed to remake high value plastics, such as bottles. Typically, recycled plastic bottles are used in carpets and fabrics due to the polymer degradation that occurs during the recycling process that inhibits it from being processed back into bottles. This degradation is due to cross linking and polymer branching that reduces the molecular weight and viscosity of the polymer. The disclosed compositions and methods use specific additives to maintain the favorable viscosity and molecular weight properties of the original polyester polymer. Examples suitable additives include epoxide compounds such as sterically hindered epoxides, acetylated bulky phenols like BHT, and bulky phenolic carboxylates that will cap free hydroxy (—OH) groups and thereby stop side reactions that would otherwise decrease the value of the recycled polymer. Such additives address the challenges of current chain extenders, which lead to uncontrolled branching and crosslinking, by providing alternative chain extenders that: 1) form stable linkages, 2) are easy to scale up, 3) provide efficient reaction for high-speed processes; and 4) do not exhibit side reactions (branching, crosslinking). The epoxide-based chain extenders can lead to sterically hindered hydroxy groups, coupled with in situ acetylation to mask the newly generated hydroxy groups, and thus make them non-reactive during mechanical recycling. The disclosed compositions and methods permit recycling of used polyesters in a way that maintains their value, reduces recycling costs, decreases plastic/raw material consumption, and decreases plastic pollution.

The disclosure relates to a recyclable polyester composition including a polyester, an epoxide compound, and (optionally) a capping agent. The epoxide compound can be a sterically hindered epoxide (e.g., having at least one sterically hindered epoxide group), a polyfunctional epoxide (e.g., having at least two epoxide groups), or both (e.g., having at least two sterically hindered epoxide groups). The capping agent can be selected and included based on its ability to react with in situ-generated hydroxy groups resulting from reaction with the polyester and the epoxide compound. The capping agent is included when the epoxide compound is a polyfunctional epoxide in order to control or limit branching during chain extension. The recyclable polyester composition can be recycled using a thermal processing step such as extrusion. The inclusion of the epoxide compound provides a controlled chain extension of the polyester subjected to thermal processing in a way that controls, limits, or prevent branching and crosslinking, but which also increases polymer molecular weight in a manner that offset the molecular weight reduction associated with thermal processing in the absence of the disclosed epoxide compounds. As a result, the recycled polyester has suitable viscosity, molecular weight, and/or mechanical properties relative to its properties when originally formed, providing a recycled polyester with physical and chemical properties comparable to those of the original virgin polyester.

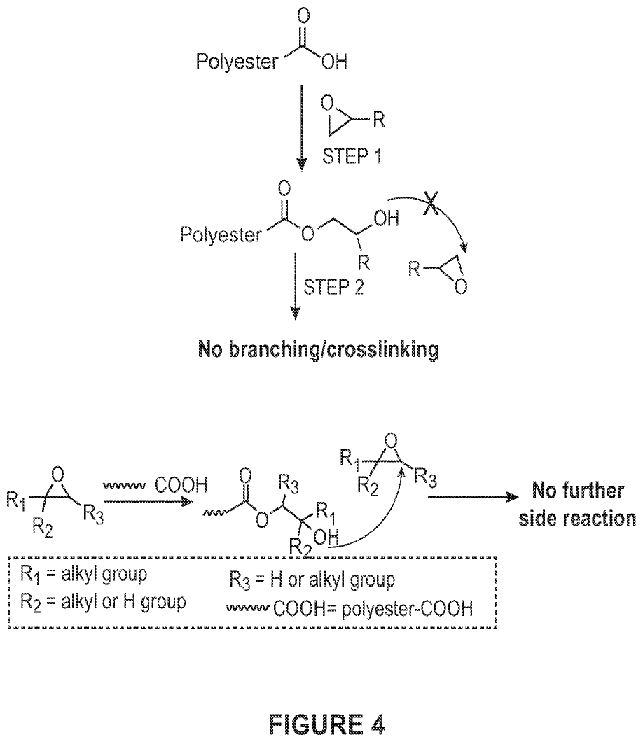

FIG. 4 illustrates reaction schemes for recycling a polyester composition using a sterically hindered epoxide according to the disclosure. As illustrated in the top portion of FIG. 4 for a generic sterically hindered epoxide, the use of a sterically hindered epoxide leads to sterically hindered hydroxyl groups upon reaction with carboxylic group in the polyester, and the resultant hindered hydroxyl moieties can be prevented from undergoing further reactions with an epoxide (denoted by an “X” for the blocked reaction). Thus, both uncontrolled branching and crosslinking are mitigated. The bottom portion of FIG. 4 illustrates the sterically hindered hydroxyl groups and relative positioning of the hindering groups R¹, R², and R³ resulting from a sterically hindered epoxide including corresponding R¹, R², and R³ groups.

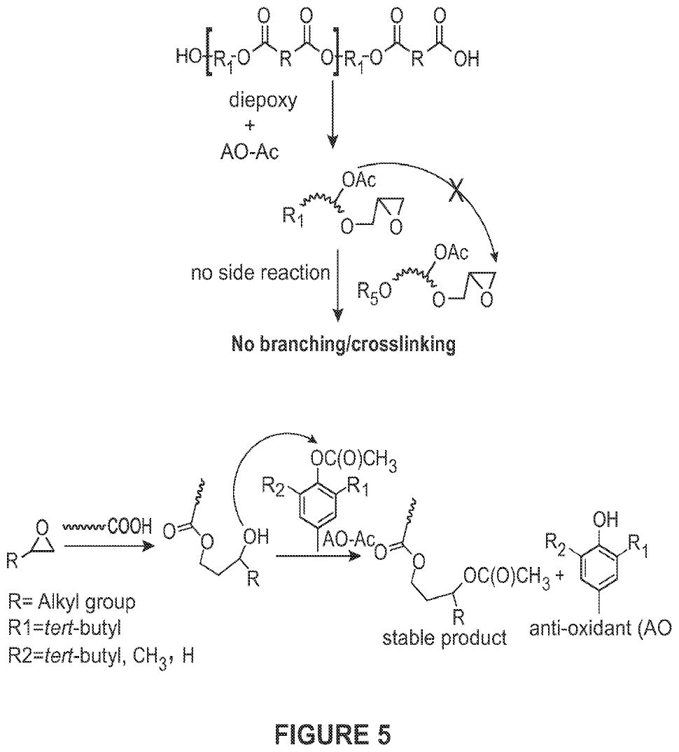

FIG. 5 illustrates reaction schemes for recycling a polyester composition using a polyfunctional epoxide and a capping agent according to the disclosure. As illustrated in the top portion of FIG. 5 for a generic polyepoxide and capping agent, the use of a capping agent such as an acetylated antioxidant (AO-Ac) can react with hydroxyl groups resulting from epoxide ring-opening, thus masking or protecting the formed hydroxyl groups (e.g., in an —OAc masking group) to limit or prevent the hydroxyl groups from undergoing further reactions with an epoxide (denoted by an “X” for the blocked reaction). Thus, both uncontrolled branching and crosslinking are mitigated. The bottom portion of FIG. 5 illustrates the structure and relative positioning of the masking capping group (—OC(O)CH₃) and the functional groups R, R¹, and R² resulting from a generic polyepoxide and acetylated bulky phenol capping agent including corresponding R, R¹, and R². The general methods illustrated in FIGS. 4 and 5 can be together together or separately to limit or prevent branching and crosslinking in polyesters.

The polyester in the recyclable composition is not particularly limited, and it can be a virgin polyester or a recycled polyester, including blends of two or more polyesters (e.g., virgin and/or recycled), such that it can incorporated into the recyclable polyester composition for a second or subsequent recycling process. Put another way, polyesters can be recycled multiple times using the disclosed compositions and methods after several product lifecycles in which a polyester product is made, used until its end of life, recycled according to the disclosure, and then re-formed into a new polyester product. In various embodiments, the polyester can include a reaction product between an alkylene diol and a dicarboxylic acid, a reaction product of a single monomer having hydroxy and acid functionality, and/or reaction product between an epoxide compound and an anhydride compound. The polyester (or sum of all polyesters) can be present in the recyclable polyester composition in an amount ranging from 50 wt. % to 99 wt. %. Suitably, the polyester can be at least 50, 60, 70, or 80 wt. % and/or up to 70, 80, 90, 95, 98, or 99 wt. % of the recyclable polyester composition.

As described above, the polyester can be a thermoplastic polyester reaction product between an alkylene diol and a dicarboxylic acid or an ester thereof. Suitable dicarboxylic acids can include aromatic, aliphatic, or cycloaliphatic dicarboxylic acids. Example aromatic dicarboxylic acids include 2,6-naphthalenedicarboxylic acid, terephthalic acid, and isophthalic acid, and mixtures of these. The aromatic ring can be substituted, for example with a halogen, such as chlorine or bromine, or C1-C4 alkyl, such as methyl, ethyl, isopropyl, n-propyl, n-butyl, isobutyl, or tert-butyl group. The dicarboxylic acid can also have a heteroatom-substituted ring (e.g., an aromatic ring including one or more N, O, or S heteroatoms), for example as furan-2,5-dicarboxylic acid. Example aliphatic or cycloaliphatic dicarboxylic acids include adipic acid, succinic acid, azelaic acid, sebacic acid, dodecanedioic acids, and cyclohexanedicarboxylic acids. Suitable alkylene diols can include aliphatic or cycloaliphatic dihydroxy compounds, for example diols having from 2 to 6 carbon atoms, in particular 1, 2-ethanediol, 1,3-propanediol, 1,4-butanediol, 1,6-hexanediol, 1,4-hexanediol, 1,4-cyclohexanediol, 1,4-cyclohexanedimethylanol, and neopentyl glycol, and mixtures of these. For example, the polyester can be a polyalkylene terephthalate preferably having from 2 to 10 carbon atoms in the alkylene diol moiety, for example polyethylene terephthalate (PET). Polyalkylene terephthalates of this type can be prepared by reacting aromatic dicarboxylic acids, or their esters or other ester-forming derivatives, with suitable dihydroxy or diol compounds as described above. Specific examples include polyethylene terephthalate, polytrimethylene terephthalate, polybutylene terephthalate, polyethylene furanoate, polypropylene furanoate, etc.

As described above, the polyester can be a thermoplastic polyester reaction product of one or more monomers having hydroxy and acid functionality, for example a monomer having a mono-hydroxy and a mono-acid functionality. Examples of such polyesters include polyglycolic acid (PGA or polyglycolide), polylactic acid (PLA or polylactide), polyhydroxyalkanotes (PHA) (e.g., poly(3-hydroxybutyrate), poly(3-hydroxyvalerate), and polylactones (e.g., polycaprolactone (PCL), polybutyrolactone, polyvalerolactone).

As described above, the polyester can be a thermoplastic polyester reaction product between an epoxide compound and an anhydride compound. Such reaction products can be prepared via catalyzed and uncatalyzed ring opening polymerization. Suitable polyesters can include those prepared from the copolymerization of a mono-substituted epoxide, for example 1,2-epoxy alkanes, epoxy cycloalkanes, epoxy aromatics, etc. with a cyclic anhydride, for example maleic anhydride, phthalic anhydride, itaconic anhydride, etc. Examples of such epoxidized hydrocarbons include alkanes, cycloalkanes, aromatic compounds, or other hydrocarbons having at least 2, 4, 6, 8, or 10 and/or up to 6, 10, 14, 20, or 30 carbon atoms in their skeleton and at least one (or only one) epoxide or ethylene oxide group.

Further examples of suitable selections for polyesters, whether as single polyesters or blends of two or more different polyesters, include polyethylene terephthalate (PET), polyethylene terephthalate glycol-modified (PETG) polytrimethylene terephthalate (PTT), polybutylene terephthalate (PBT), polyethylene isosorbide terephthalate (PEIT), polylactic acid (PLA), polyhydroxy alkanoate (PHA), polybutylene succinate (PBS), polybutylene succinate adipate (PBSA), polybutylene adipate terephthalate (PBAT), polyethylene furanoate (PEF), polycaprolactone (PCL), poly(ethylene adipate) (PEA), polybutylene succinate terephthalate (PBST), polyethylene succinate (PES), poly(butylene succinate/terephthalate/isophthalate)-co-(lactate) (PBSTIL), liquid crystalline polyesters, and combinations thereof. Examples of suitable blends include PET/PETG and PET/PLA. Further examples of suitable selections polyesters include copolyesters such as isophthalate-modified copolyesters, sebacic acid-modified copolyesters, diethyleneglycol-modified copolyesters, triethyleneglycol modified-copolyesters, cyclohexanedimethanol modified-copolyesters, and/or polybutylene terephthalate. Such modified copolyesters generally have at least one of the TPA or EG units in PET at least partially replaced with modifying unit (e.g., at least some terephthalic units replaced with isophthalic units, at least some ethylene glycol units replaced with diethyleneglycol units), for example with 2-50 mol. %, 5-50 mol. %, 10-40 mol. %, 10-20 mol. %, 20-30 mol. %, or 15-30 mol. % replacement by the modifying unit.

The epoxide compound in the recyclable composition can be a sterically hindered epoxide, a polyepoxide, or both. For example, the epoxide compound can include 1, 2, 3, 4, or more sterically hindered epoxide groups, such as being free from non-sterically hindered epoxide groups. Similarly, the epoxide compound can include 2, 3, 4, or more epoxide groups, such as being free from sterically hindered epoxide groups. In some embodiments, the epoxide compound can include 1, 2, 3, 4, or more sterically hindered epoxide groups and 1, 2, 3, 4, or more non-sterically hindered epoxide groups. The epoxide compound can include an alkyl, alkenyl, aromatic, or other hydrocarbon structure having at least 2, 4, 6, 8, or 10 and/or up to 6, 10, 14, 20, or 30 carbon atoms in its skeleton along with the one or more epoxide (or sterically hindered epoxide) groups. In some embodiments, the epoxide compound can be an oligomer or polymer including at least one epoxide-functional monomer or comonomer. An example of an oligomeric or polymeric polyepoxide without sterically hindered epoxide groups (e.g., for use in combination with a capping agent according to the disclosure) is JONCRYL ADR-4300 (available from BASF) For example, the polyfunctional epoxide can have at least 2, 3, 4, 6, 8, 10, 20, or 30 and/or up to 10, 20, 40, 60, 80, or 100 epoxy groups, whether sterically hindered, non-sterically hindered, or a combination of both. The epoxide compound (or sum of all epoxide compounds) can be present in the recyclable polyester composition in an amount ranging from 0.1 wt. % to 50 wt. %. For example the epoxide compound(s) can be at least 0.1, 1, 2, 5, 10, 15, 20, or 30 wt. % and/or up to 10, 20, 30, 40, or 50 wt. % of the recyclable polyester composition.

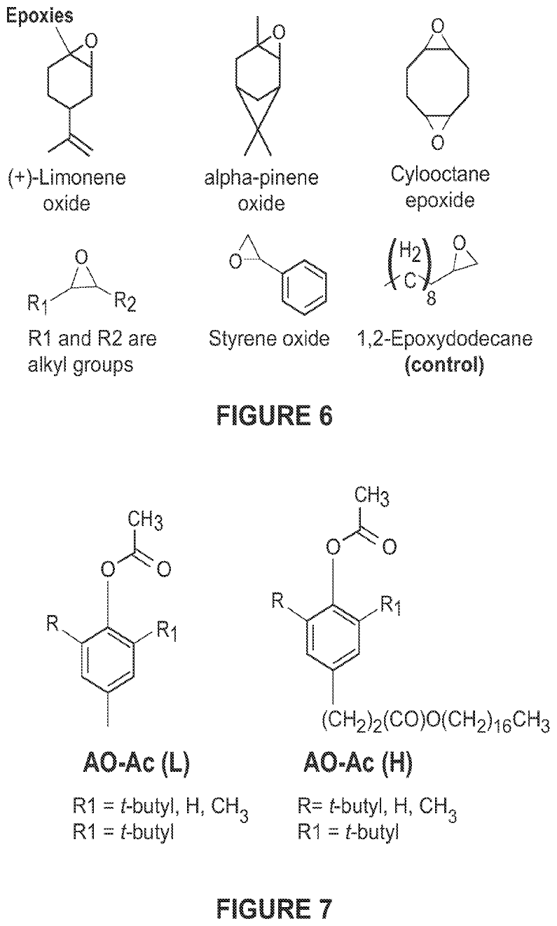

As described above, the epoxide compound can be a sterically hindered epoxide. A sterically hindered epoxide limits side reactions during recycling by generating hindered (e.g., tertiary) hydroxy groups. A hindered hydroxy group can be expressed a R₁R₂R₃COH, where the R₁-R₃ groups are all other than hydrogen (e.g., including a carbon atom linked to other atoms). Examples of sterically hindered epoxides include (+)-limonene 1,2-epoxide, alpha-pinene 1,2-epoxide, (−)-caryophyllene 1,2-epoxide, cyclooctane 1,2-epoxide, styrene 1,2-epoxide, and epoxidized oils. Suitable epoxidized oils can include epoxidized plant or other natural-based oils, for example fatty acid triglycerides with 1, 2, or more than two epoxide groups on the pendant fatty acid chains. FIG. 6 illustrates representative sterically hindered epoxide structures.

In an embodiment, the sterically hindered epoxide can be represented by formula (I):

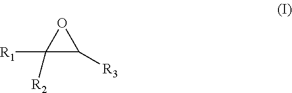

In formula (I), R₁ is an alkyl or an aryl group; R₂ is hydrogen, an alkyl group, or an aryl group; and R₃ is hydrogen, an alkyl group, an aryl group, or together with R₁ is a cycloalkyl group. Suitably, at least one of R₂ and R₃ is other than hydrogen. The alkyl and aryl groups of R₁, R₂, and R₃ can be the same or different, and they can be hydrocarbons including at least 1, 2, 4, 6, 8, 10, 15, or 20 and/or up to 4, 6, 10, 14, 20, 30, 40, 50, or 60 carbon atoms. The hydrocarbons can be any of linear, branched, cyclic, aliphatic, aromatic, etc., and they can include heteroatoms (e.g., N, O, S) or other epoxide functional groups. In various embodiments, the sterically hindered epoxide includes 1, 2, or more than two epoxide groups.

In an embodiment, the polyfunctional epoxide includes two or more hindered epoxy functional groups. For example, the polyfunctional epoxide can have at least 2, 3, 4, 6, 8, 10, 20, or 30 and/or up to 10, 20, 40, 60, 80, or 100 hindered epoxy groups. The steric hindrance at each hindered epoxide group can be similar or otherwise analogous to that described above for formula (I). Examples include cyclooctene diepoxide, epoxided plant oils with multiple epoxide groups, diepoxy limonenes, etc. In addition, polymers or copolymers of 4-epoxy-styrene and other polymerizable hindered epoxides can be used as a polyfunctional chain extender according to the disclosure.

As described above, the epoxide compound can be a polyfunctional epoxide (e.g., with or without sterically hindered epoxide groups) included in combination with a capping agent. Capping agents can include acetylated bulky phenols and/or oxazoline compounds, for example. Inclusion of the capping agent can limit side reactions during recycling by generating hydroxy groups and reacting them in situ during mechanical recycling with a capping agent such as an acetylated bulky phenol. A mono-oxazoline capping agent can limit side reactions by reacting with the in situ-generated hydroxy groups resulting from ring opening. Examples of mono-oxazolines includes those in which the oxazoline ring is unsubstituted or substituted, for example with a halogen, an alkyl or other hydrocarbon group, etc. Such mechanisms of reducing side reactions can be in addition to those resulting from the inclusion of sterically hindered epoxide groups. The capping agent can be included in an amount of least 0.1, 1, 2, or 5 wt. % and/or up to 2, 3, 5, 7, or 10 wt. % of the recyclable polyester composition.

In an embodiment, the capping agent can be an acetylated bulky phenol having a structure according to formula (II):

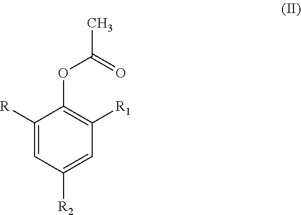

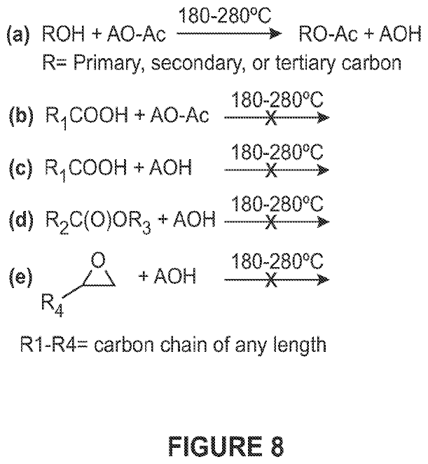

In formula (II), R is hydrogen, a linear alkyl group (e.g., H, methyl, ethyl), or a branched alkyl group (e.g., tert-butyl); R₁ is a branched alkyl group (e.g., tert-butyl); and R₂ is a hydrocarbon group (e.g., alkyl group such as methyl or a hydrocarbon chain with one or more heteroatoms or other functional group, such as an ester group). More generally, the alkyl groups of R, R₁, and R₂ can be the same or different, and they can be hydrocarbons including at least 1, 2, 4, 6, 8, or 10 and/or up to 4, 6, 10, 14, or 20 carbon atoms. The hydrocarbons can be any of linear, branched, cyclic, aliphatic, aromatic, etc., and they can include heteroatoms (e.g., N, O, S) or other functional groups. More generally, the acetylated bulky phenol includes an acetylated phenolic group, which can be represented by CH₃(C═O)O-Ph, where Ph is a phenyl group that contains at least one bulky substituent on the phenyl ring in an ortho position relative to the acetyl group (CH₃(C═O)). The bulky substituent can be a tert-butyl or other branched or cyclic hydrocarbon. In some embodiments, the acetyl group (CH₃(C═O)) can be replaced more generally with a longer alkyl or aromatic carbonyl group R(C═O), where R can be a hydrocarbon group with 1 to 10 carbon atoms (e.g., at least 1, 2, or 4 and/or up to 4, 6, 8 or 10 carbon atoms), such as a linear or branched alkyl group or an aromatic group. In some embodiments, the phenolic group can be replaced more generally with a dimeric or polyphenolic group, for example a hindered phenol such as 3,5-di-tert-butyl-4-hydroxy benzyl acrylate. FIG. 7 illustrates representative acetylated bulky phenol (AO-Ac) structures that can be used as capping agents according to the disclosure, and FIG. 8 illustrates representative reactions that can occur or can be inhibited/prevented when using capping agents according to the disclosure.

In some embodiments, the polyester(s), the epoxide compound(s), and the capping agent(s) constitute the substantial majority of the recyclable polyester composition. For example, at least 90, 95, 98, or 98 wt. % of the recyclable polyester composition can be the polyester(s), the epoxide compound(s), and the capping agent(s) (when present) combined. Similarly, in some embodiments, the recyclable polyester composition does not contain more than 1, 2, 5, or 10 wt. % of other additives or components besides the polyester, epoxide compound, and capping agent.

In some embodiments the recyclable polyester composition can include one or more additives. The polyester composition can include any suitable organic or inorganic filler or additive, which can be included to improve one or more of mechanical properties, optical properties, electrical properties, and omniphobic properties of the final composition. Examples of suitable fillers or additives include nanoclay, graphene oxide, graphene, fibers (e.g., carbon fiber, glass fiber, aramid fiber), silsesquioxane, silicon dioxide (silica), aluminum oxide, diatomaceous earth, cellulose nanocrystals, carbon nanotubes, titanium dioxide (titania), and combinations or mixtures thereof. In addition, the fillers can include biocides, pigments, dyes, a thermoplastic material, or a combination thereof. The fillers can be added in the range from 0.01 wt. % to 10 wt. % or 0.01 wt. % to 50 wt. %, for example in range from 1 wt. % to 5 wt. % or 1 wt. % to 20 wt. %.

The recyclable polyester composition according to the disclosure can be recycled via thermal processing, for example melt-processing such as extruding. In some embodiments, the melt-processing corresponds to a mechanical recycling step in which the thermoplastic polyester to be recycled is heated to a temperature above its melting temperature and below its decomposition temperature, for example in an extruder, so that it can be formed into any desired shape (e.g., pellets or granules for any desired subsequent use). Common melt-processing temperatures can range from about 80° C. to 280° C. (e.g., at least 80, 150, or 200° C. and/or up to 150, 200, 250, or 280° C.), which is typically suitable for common polyesters such as PET and PLA. Higher or lower temperatures may be suitable for other polymers with varying melting points. For example, melt-processing can be performed at a temperature that is at least 10 or 20° C. and/or up to 50 or 100° C. above the melting point of the polyesters. In an alternative embodiment, thermal processing can include heating to perform solid state polycondensation or polymerization (SSP), either with or without melt-processing the recycled polyester composition. For example, the recyclable polyester composition could be first melt-processed, and then subjected to SSP, or the recyclable polyester composition could be subjected to SSP without melt-processing.

The recycling process has the benefit that the addition of the epoxide compound and capping agent (in some embodiments) offsets the typical reduction in molecular weight and/or viscosity associated with mechanical recycling.

For example, the polyester (or recyclable polyester composition) can be characterized as having a first molecular weight prior to recycling and a second molecular weight after recycling. In such cases, the ratio of the first molecular weight:second molecular weight is at least 0.7, 0.8, or 0.9. The upper bound for the molecular weight ratio is not particularly limited, but in various embodiments it can be up to 1.2, 1.5, 2, 5, 10, 20, 50, 100, or 1000. In some embodiments, it can be desired to obtain a final molecular weight comparable to the initial molecular weight such that the ratio could be up to 1.2, 1.5, or 2. In other embodiments, it can be desired to substantially increase the molecular weight while still retaining the thermoplastic character of the polymer. In such cases, the amount of the epoxide compound can be adjusted to provide controlled chain extension to create longer polymer chains with correspondingly higher polymer molecular weights, but without introducing substantial branching or crosslinking. In such cases, the molecular weight ratio could be up to 5, 10, 20, 50, 100, or 1000. This ratio can based on either the number-average or weight-average molecular weight. After an initial mechanical recycling process with thermal processing, the polyester could exhibit a reduction of molecular weight of up to 80%. The epoxide compound chain extenders of the present disclosure can offset this reduction and recover/increase the molecular weight of the recycled polyester without substantial branching or crosslinking. The recycled polyester can broadly have a molecular weight in a range of 1000-10,000,000 g/mol after the chain extension, for example at least 1,000, 10,000, 100,000, 1,000,000 and/or up to 10,000, 100,000, 1,000,000, or 10,000,000 g/mol (e.g., number- or weight-average).

Similarly, the polyester (or recyclable polyester composition) can be characterized as having a first viscosity prior to recycling and a second viscosity after recycling. In such cases, the ratio of the first viscosity:second viscosity can be at least 0.7, 0.8, or 0.9. The upper bound for the viscosity ratio is not particularly limited, but in various embodiments it can be up to 1.2, 1.5, 2, 5, 10, 20, 50, 100, or 1000. In some embodiments, it can be desired to obtain a final viscosity comparable to the initial viscosity such that the ratio could be up to 1.2, 1.5, or 2. In other embodiments, it can be desired to substantially increase the viscosity while still retaining the thermoplastic character of the polymer. In such cases, the amount of the epoxide compound can be adjusted to provide controlled chain extension to create longer polymer chains with correspondingly higher polymer viscosities, but without introducing substantial branching or crosslinking. In such cases, the viscosity ratio could be up to 5, 10, 20, 50, 100, or 1000. The first and second viscosity values (and corresponding ratio) similarly can apply to the recyclable polyester composition and recycled polyester composition, respectively for the before/after comparison. Viscosity can be measured using any suitable viscometer, for example measuring the viscosity of the molten polymer composition itself or a solution of the polymer composition dissolved in a suitable solvent. The two viscosity values can be measured at any suitable reference conditions (e.g., temperature, concentration, etc.) as long as the reference conditions are the same for both measurements (i.e., providing a consistent ratio for comparison). The final viscosity of the polyester or corresponding polymer composition can be further adjusted to have a melt-flow index suitable for subsequent downstream processing into a new product, for example processing via injection molding, extrusion blown films, extrusion blow molding, etc.

### EXAMPLES

The following examples illustrate the disclosed compositions and methods, but are not intended to limit the scope of any claims thereto.

### Example 1

This example illustrates the use of a polymeric sterically hindered polyepoxide as a chain extender for PLA. The sterically hindered polyepoxide was a copolymer between sterically hindered monoepoxy styrene (MES or 4-epoxy styrene) monomer units with methylmethacrylate (MMA) and butylmethacrylate (BMA) monomer units. A commercially available conventional oligomeric polyepoxide (JONCRYL ADR-4300) was used as a chain extender for PLA in a comparative formulation. A PLA resin was melt-processed separately with either the sterically hindered polyepoxide chain extender or the commercial chain extender through an extrusion process, and the prepared samples were tested for their tensile properties. The sterically hindered polyepoxide according to the disclosure provided a chain-extended PLA with substantially improved tensile strength and elongation properties.

Materials: The following materials were used as provided by their respective manufacturers: polylactic acid (PLA, INGEO BIOPOLYMER 4032D), toluene (MilliporeSigma), 2,2′-azobis(2-methylpropionitrile) (AIBN, MilliporeSigma), methylmethacrylate (MMA, MiliporeSigma), butylmethacrylate (BMA, MiliporeSigma), 1,4-divinylbenzene (DVB, MiliporeSigma), m-chloroperoxybenzoic acid (mCPBA, MiliporeSigma), dichloromethane (DCM, MiliporeSigma), and JONCRYL ADR-4300 (BASF).

Synthesis of Monoepoxy Styrene (MES): 10.5g of mCPBA was dissolved in dichloromethane. Then, 5g of DVB was added and the mixture in solvent was stirred overnight at room temperature on a magnetic stirrer hotplate. The progress of reaction was monitored by ¹HNMR spectroscopy. After completion of reaction, monoepoxy styrene was extracted by solvent extraction and solvent was evaporated by rotary evaporator. The product was characterized by ¹HNMR spectroscopy.

Synthesis of Poly(BMA-MMA-MES): The polymeric sterically hindered polyepoxide was formed using a 60:30:10 molar ratio for the BMA:MMA:MES monomer. Monoepoxy styrene (MES), methylmethacrylate (MMA), butylmethacrylate (BMA), toluene (at a three-fold excess with respect to the monomers by volume) and 2,2′-azobis(2-methylpropionitrile) (AIBN, 2-3 wt % of the monomers) were charged in a high-pressure glass reaction flask under nitrogen atmosphere in a glove box. The toluene solvent had been previously purged with nitrogen gas in order to free it from entrapped oxygen. The reaction flask was kept on a hot plate overnight at 70° C. under stirring. The reaction conversion was evaluated via proton nuclear magnetic resonance (¹HNMR) spectroscopy by characterizing samples collected from the reaction mixture. After completion of the reaction, the synthesized polymer was precipitated in methanol/water solution and dried in vacuum oven at 35° C. The dried polymer was ground into a powder using a mortar and pestle, and preserved in a sealed bag. The mole fraction of sterically hindered monoepoxy styrene units in the final precipitated polymer was measured by NMR to be about 8-9 mol. %, which was consistent with the initial molar ratio of the monomer units. The polymer had a molecular weight of about 1560 g/mol.

Extrusion and Test Sample Preparation: The extrusion was performed using a DSM XPLORE 15cc MICRO EXTRUDER equipped with co-rotating conical twin-screws. First, the pre-mixed ingredients (as summarized in Table 1 below) were fed in hopper of DSM extruder. The different relative weight-fraction amounts of JONCRYL ADR-4300 (1 wt. %) and poly(BMA-MMA-MES) (3 wt. %) were selected such that the total epoxide functionality (i.e., on a number or mole basis) of each chain extender was substantially the same. After the complete addition of all ingredients, the PLA material was compounded for 3-4 minutes. Finally, the molten mixture was injection molded using 3.5cc injection molder. The molten extruded mixture was injection molded into dumbbell shaped specimens for tensile testing.

TABLE 1
Sample code designations and description

| | | Temperature |
|---|---|---|
| Sample Code | Compositions | and time |
| PLA | PLA (100 g) | 180° C. |
| | | for 3 min |
| PLA-JONCRYL | PLA (99 g) and JONCRYL | 180° C. |
| ADR-4300 | ADR-4300 (1 g) | for 3 min |
| PLA-Poly(BMA- | PLA (97 g):Poly(BMA/ | 180° C. |
| MMA-MES) | MMA/MES) (3 g) | for 3 min |

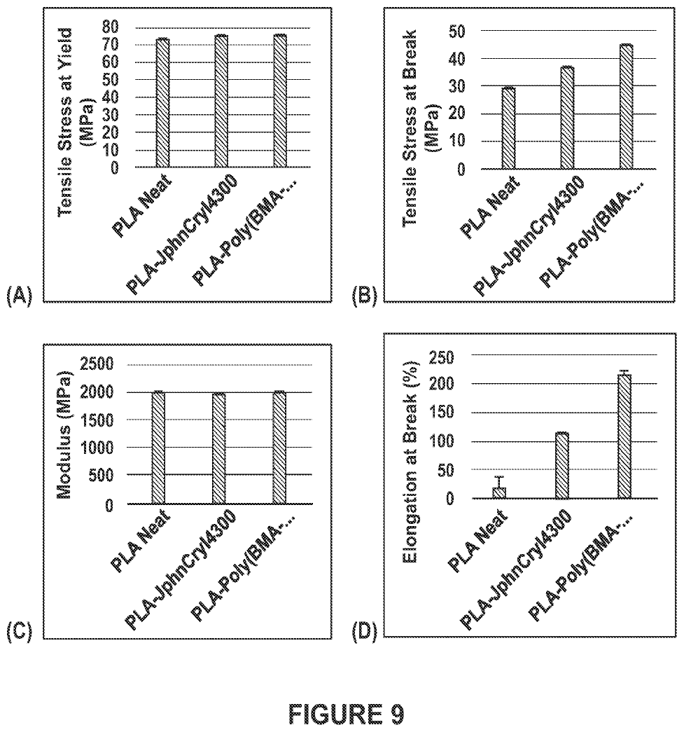

Characterization and Results: Tensile properties of prepared samples were evaluated using a computer-controlled universal testing machine (Instron 5565) according to ASTM D-638. The samples were tested at a crosshead speed of 10 mm/min. FIG. 9 illustrates the measured tensile properties for the test samples, including (A) tensile stress at yield, (B) tensile stress at break, (C) modulus, and (D) elongation at break. As shown in the graphs, the sterically hindered polyepoxide according to the disclosure provided a chain-extended PLA with substantially improved tensile strength at break and elongation at break properties relative to both neat PLA and PLA chain-extended with a conventional (not sterically hindered) polyepoxide having substantially the same degree of epoxide group functionality as the sterically hindered polyepoxide.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A recyclable polyester composition comprising:
a polyester;
an epoxide compound comprising at least one of a sterically hindered epoxide and a polyfunctional epoxide; and
optionally a capping agent reactive with in situ-generated hydroxy groups resulting from reaction with the polyester and the epoxide compound, wherein the capping agent is present when the polyester composition comprises the polyfunctional epoxide.

2. The composition of claim 1, wherein the polyester comprises a thermoplastic polyester reaction product between an alkylene diol and a dicarboxylic acid.

3. The composition of claim 1, wherein the polyester comprises polyethylene terephthalate (PET).

4. The composition of claim 1, wherein the polyester comprises polylactic acid (PLA).

5. The composition of claim 1, wherein the polyester comprises the polyester comprises a thermoplastic polyester reaction product between an epoxide compound and an anhydride compound.

6. The composition of claim 1, wherein the recyclable polyester composition comprises the sterically hindered epoxide.

7. The composition of claim 6, wherein the sterically hindered epoxide has a structure according to formula (I): 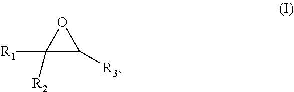
wherein:
R₁ is an alkyl or an aryl group;
R₂ is hydrogen, an alkyl group, or an aryl group;
R₃ is hydrogen, an alkyl group, an aryl group, or together with R₁ is a cycloalkyl group; and
at least one of R₂ and R₃ is other than hydrogen.

8. The composition of claim 6, wherein the sterically hindered epoxide is selected from the group consisting of (+)-limonene 1,2-epoxide, alpha-pinene 1,2-epoxide, (−)-caryophyllene 1,2-epoxide, cyclooctane 1,2-epoxide, styrene 1,2-epoxide, and epoxidized oils.

9. The composition of claim 1, wherein the recyclable polyester composition comprises the polyfunctional epoxide and the capping agent.

10. The composition of claim 9, wherein the polyfunctional epoxide comprises at least two hindered epoxy functional groups.

11. The composition of claim 9, wherein the capping agent comprises an acetylated bulky phenol having a structure according to formula (II): 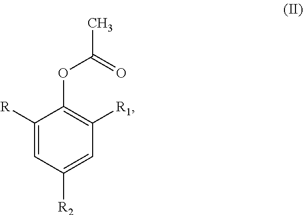
wherein:
R is hydrogen, a linear alkyl group, or a branched alkyl group;
R₁ is a branched alkyl group; and
R₂ is a hydrocarbon group.

12. The composition of claim 9, wherein the capping agent comprises a mono-oxazoline.

13. The composition of claim 9, wherein:
the polyfunctional epoxide is selected from the group consisting of cyclooctene diepoxide, polyepoxided plant oils, diepoxy limonenes, polymers or copolymers of 4-epoxy-styrene, and combinations thereof; and
the capping agent is selected from the group consisting of acetylated butylated hydroxytoluene (BHT), polymers and copolymers of 3,5-di-tert-butyl-4-hydroxy benzyl acrylate, a mono-oxazoline, and combinations thereof.

14. The composition of claim 1, wherein:
the polyester is present in the recyclable polyester composition in an amount ranging from 50 wt. % to 99 wt. %; and
the epoxide compound is present in the recyclable polyester composition in an amount ranging from 0.1 wt. % to 50 wt. %.

15. The composition of claim 1, further comprising one or more additives selected from the group consisting of nanoclay, graphene oxide, graphene, fibers, silicon dioxide (silica), aluminum oxide, cellulose nanocrystals, carbon nanotubes, titanium dioxide (titania), diatomaceous earth, biocides, pigments, dyes, thermoplastics, and combinations thereof.

16. A method for recycling a polyester composition, the method comprising:
providing a recyclable polyester composition according to claim 1; and
thermally processing the recyclable polyester composition to provide a recycled polyester composition.

17. The method of claim 16, wherein thermally processing comprises melt-processing the recyclable polyester composition.

18. The method of claim 16, wherein thermally processing the recyclable polyester composition comprises reacting the epoxide compound with at least one of (i) hydroxyl end groups on polymeric chains of the polyester and (ii) carboxylic end groups on polymeric chains of the polyester, thereby chain-extending the polyester.

19. The method of claim 16, wherein:
the polyester has a first viscosity prior to recycling;
the polyester has a second viscosity after recycling; and
the ratio of the first viscosity:second viscosity is at least 0.9.

20. The method of claim 16, wherein:
the polyester has a first molecular weight prior to recycling;
the polyester has a second molecular weight after recycling; and
the ratio of the first molecular weight:second molecular weight is at least 0.9.

21. The method of claim 16, wherein providing the recyclable polyester composition comprises:
providing the polyester; and
adding the epoxide compound and the capping agent (when present) to the polyester.
